(19) United States
(12) Patent Application Publication
(10) Pub. No.: US 2005/0105026 A1
(43) Pub. Date: May 19, 2005

(54) Combination of cholesteric layer and alignment layer

(75) Inventors: Gerardus Petrus Karman, Eindhoven (NL); Ciska Doornkamp, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V.

(21) Appl. No.: 10/501,854

(22) PCT Filed: Jan. 13, 2003
(86) PCT No.: PCT/IB03/00070

(30) Foreign Application Priority Data
Jan. 17, 2002 (EP) 02075201.0

(51) Int. Cl. G02F 1/1335

(52) U.S. Cl. 349/115

(57) ABSTRACT

A cholesteric layer switchable between a wavelength-selectively reflective state and a transmissive state is in direct contact with a homeotropic orientation layer. In the reflective state the layer is cholesterically ordered in helices characterized by a helical direction and a helical pitch. The homeotropic layer broadens the distribution of helical axis directions thus rendering the light reflected in the reflective state more diffuse and rendering the color reflected by the cholesteric layer less dependent on viewing angle. Alternatively, the cholesteric layer may be a polymerized layer.

The invention relates to a combination of a cholesteric layer and an alignment layer.

The invention also relates to a polymerized cholesteric layer.

Cholesteric layers are capable of exhibiting optical effects which are useful in lighting and display applications. Such effects may relate to the polarization, the color and/or the direction of the incident light.

In a cholesterically ordered state the cholesteric layer is, on a molecular scale, ordered to form helices, such helices being characterized by a helical axis and a pitch. In one such cholesterically ordered state, in the art also referred to as the planar texture, the helical axes are oriented at substantially right angles to a reference surface, the reference surface typically corresponding to a major surface of the layer or a surface of a substrate supporting the cholesteric layer. In the planar texture the cholesteric layer operates as a Bragg reflector capable of reflecting electromagnetic radiation, hereinafter simply referred to as light, wavelength-selectively and polarization-selectively. Generally, for normally incident electromagnetic radiation and constant pitch, a narrow band of wavelengths is reflected, the band having a central wavelength λ=n.p and a bandwidth Δλ=Δn.p, wherein n is the average refractive index of the cholesteric layer, Δn is the birefringence of the nematic phase corresponding to the cholesteric layer, and p is the helical pitch. Thus, desired reflected wavelengths are selected by selecting an appropriate helical pitch and birefringence. Since the helical pitch perceived by incident light is a function of the angle at which the light is incident, the wavelengths of the light reflected depends on the angle at which the light is incident, that is if white light is incident the color of the reflected light depends on the angle at which the light is incident. For display applications this means that the color perception of the image depends on the viewing angle.

In an article by St John et al in Phys. Rev. E 51(2), 1995, p 1191 a display comprising a cholesteric layer having such a planar texture is disclosed. The cholesteric layer is sandwiched between substrates provided with transparent ITO electrodes. To bring the cholesteric layer in the planar texture, the substrates are provided with polyimide alignment layers. By applying a voltage to the cell the cholesteric layer is switched from the planar texture to a focal conic texture. In the planar texture the cholesteric layer specularly reflects brilliantly colored light. In the focal-conic texture, which is characterized by a broad distribution of helical axis directions, the cholesteric layer is transmissive.

In order to improve the viewing angle of the display, St John et al propose to use an imperfect planar texture. In the imperfect planar texture the helical axes have a broadened distribution about the normal of the reference surface. According to St John et al, this can be achieved by dispersing polymer in the cholesteric layer. Alternatively, the cholesteric layer may be applied on a rough surface. Khan et al. SID D1 Digest pages 460-463 suggest to improve viewing angle dependency by means of unrubbed polyimide alignment layers.

It is an object of the invention, inter alia, to provide a combination comprising cholesteric layer having alternative means for reducing the viewing angle dependency of its optical properties. Specifically, the reflective state is to reflect less specular, that is more diffusely, and the color reflected by the cholesteric layer in the reflective state is to be less dependent on viewing angle. Furthermore, the alternative means should allow the manufacture of the cholesteric layer to be commensurate with conventional methods for processing layers exhibiting or capable of exhibiting mesoscopic phases such as liquid crystal layers.

In accordance with the invention, this object is achieved by a combination of a cholesteric layer switchable between a cholesterically ordered wavelength-selectively reflective state and a transmissive state and a homeotropic orientation layer which is in direct contact with the cholesteric layer.

The homeotropic alignment layer has the effect of rendering the light reflection by the cholesteric layer in the reflective state more diffuse and less specular and at the same time it reduces the viewing angle dependency of the color of the reflected light.

Although not wishing to be bound by any theory, in accordance with the teachings of St John et al, the inventors believe that the homeotropic alignment layer affects the order of the cholesteric order in the reflective state. Specifically, it broadens the distribution of helical axis directions within the cholesteric layer. At each specific viewing angle, the broadened range of helical axis directions leads to a broadened range of reflected wavelengths. In addition the broadened wavelength range shifts as a function of viewing angle, the resultant effect that a particular wavelength is reflected in a wider range of viewing angles. In other words, the color reflected by the cholesteric layer is less dependent on viewing angle. For further details reference is made to the said article of St John et al.

Use of an alignment layer to bring about the desired order of the cholesteric layer renders the manufacture of the combination commensurate with conventional liquid crystal cell making methods which also use alignment layers to align the liquid crystal layer which greatly facilitates its use in optical and electro-optical applications. Moreover, homeotropic alignment layers are well known in the art and widely commerically available. The presence of the homeotropic alignment layer does not impede the switchability between the reflective state and the transmissive state.

In the context of the invention, an alignment layer is considered homeotropic if it is capable of homeotropically aligning nematic liquid crystal material, and, if the cholesteric layer is made from a chiral nematic material obtained by mixing a nematic LC material with a chiral dopant, in particular that LC nematic material. In the art an alignment layer is also referred to as an orientation layer.

In the context of the present invention, a cholesteric layer is also referred to as a chiral nematic material. If the pitch and/or birefringence is varied within the cholesteric layer, eg by stacking cholesteric layers each having a different pitch layer on to of each other or by applying a pitch gradient within a cholesteric layer the bandwidth of the reflected wavelenghts may be increased. The light reflection of a cholesteric layer is polarization-selective, it reflects circularly polarized light. Used in combination with a quarter wavelength retarder, a linear polarized light reflector is obtained.

In a particular embodiment of the combination in accordance with the invention the cholesteric layer is sandwiched between a homeotropic alignment layer and a planar alignment layer.

In order to bring about the state capable of wavelength-selectively reflecting electromagnetic radiation it is convenient to sandwich the cholesteric layer between a homeotropic alignment layer and a planar alignment layer. Planar alignment layers such as a rubbed polyimide layer are well known in the art.

The combination of cholesteric layer and homeotropic layer in accordance with the invention is capable of modulating the color, direction, intensity and/or polarization of electromagnetic radiation incident thereon and accordingly finds application in a range of optical elements such as polarizers, retarders, beam splitters (semi-transparent) reflectors, filters. Moreover, since generally cholesteric layers do not absorb electromagnetic radiation incident thereon, at least not in the visible range of the spectrum, optical components comprising such materials can be made highly efficient as light may be effectively recycled. Since there is substantially no absorption, the cholesteric layer is heated up by light incident thereon which renders the cholesteric layer suitable for high-intensity applications such as projection displays.

In particular, the cholesteric layer being switchable, it may be used for applications where the cholesteric layer is used an electro-optically active layer. wherein the switching between the reflective and transmissive state is brought about by means of an electric field. Such electro-optically switchable cholesteric layers are particularly suitable for displays.

Thus, a preferred embodiment in accordance with the invention relates to an electro-optical cell, such as a light valve or a display cell, comprising a pair of opposed substrates and a combination in accordance with the invention sandwiched between the said pair of substrates.

One advantage of an electro-optical (display) cell in accordance with this embodiment is its low cost as it does not require the use of polarizers and, if the cell operates as a reflective cell, a reflector. Furthermore, as both the planar texture and the focal-conical texture are stable textures, that is do not need an electric field to maintain the texture, the power consumption of the display is low. A cell based on switching between such states (which is not necessarily so, as switching between other states such as a homeotropically ordered states is also possible) only consumes power when the information displayed is changed and no power is needed to maintain the information displayed.

A further preferred embodiment in accordance with the invention relates to an electro-optical device, such as a display device, comprising an electro-optical cell in accordance with the invention.

The combination in accordance with the invention may be suitably used in display devices. In view of the bi-stability of the cell described hereinabove, a passive matrix display having the combination is particularly advantageous. Multi-color, even full-color devices can be obtained by stacking pixelated monochrome cells.

Although the invention has so far been described in terms of a cholesteric layer which is switchable between different states, it may also encompass non-switchable cholesteric layer such as polymerized cholesteric layer.

Therefore, in another aspect, the invention relates to a polymerized cholesteric layer in a cholesterically ordered state capable of wavelength-selectively reflecting polarized light obtainable by polymerizing a polymerizable cholesteric layer in a cholesterically ordered state capable of wavelength-selectively reflecting polarized light, the polymerizable layer being in direct contact with a homeotropic orientation layer.

Such polymerized cholesteric layer may be effectively used in (broadband) polarizers and reflective color filters to improve viewing angle dependency of the color reflected by the cholesteric layer. As explained above, the homeotropic layer modifies the orientation of the cholesteric layer in the cholesterically ordered state such that the color reflected by the cholesteric layer depends less on the viewing angle. If desired, the homeotropic alignment layer may be removed after polymerization.

The polymerized cholesteric layer may be used in optical elements and components in which it is desirable to maintain the same ordered state of the cholesteric layer throughout its operational lifetime even if exposed to high and changes in temperatures and mechanical forces. Examples of such optical elements include (polarization-sensitive) narrow band and broadband filters and reflectors, beam splitters, retardation layers. Particular advantageous is the use of the combination in accordance with the invention in a broad band reflective polarizer such as those disclosed in EP 606940 and reflective color filters such as those disclosed WO 00/33129.

Polymerized cholesteric layers are obtained by polymerizing polymerizable cholesteric layers. Polymerizable cholesteric layer contains monomers which carry polymerizable groups, examples of such groups being (meth)acrylate vinylene, vinylether, epoxide groups, oxetanes and thiol-ene systems.

Particularly high resistance is provided by cross-linked cholesteric layers also referred to as cholesteric polymer networks. Such cross-linked polymers are obtained by monomers having more than one polymerizable group such as diacrylates.

In particular when polymerized cholesteric layer is used, shaped objects formed therefrom such as film, layers can be made self-supporting. Alternatively, a separate substrate may be used to support the cholesteric layer.

These and other aspects of the invention will be apparent from and elucidated with reference to the examples described hereinafter.

In the drawings:

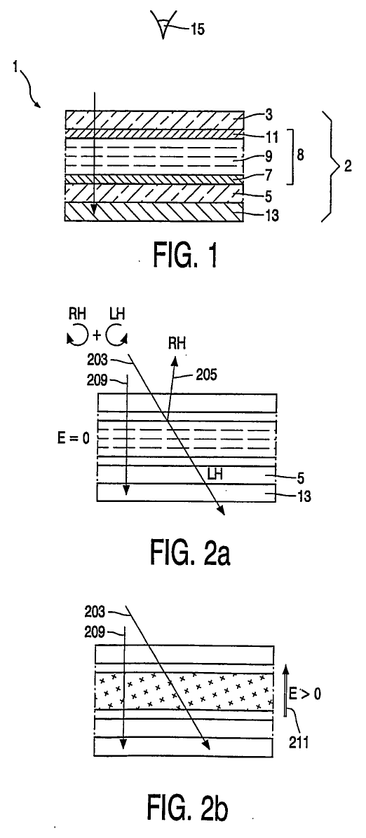

FIG. 1 shows, schematically, in a cross-sectional view a reflective display device comprising cholesteric layer,

FIGS. 2A and 2B show, schematically, the propagation of light through the display device shown in FIG. 1 in an on-state and off-state respectively,

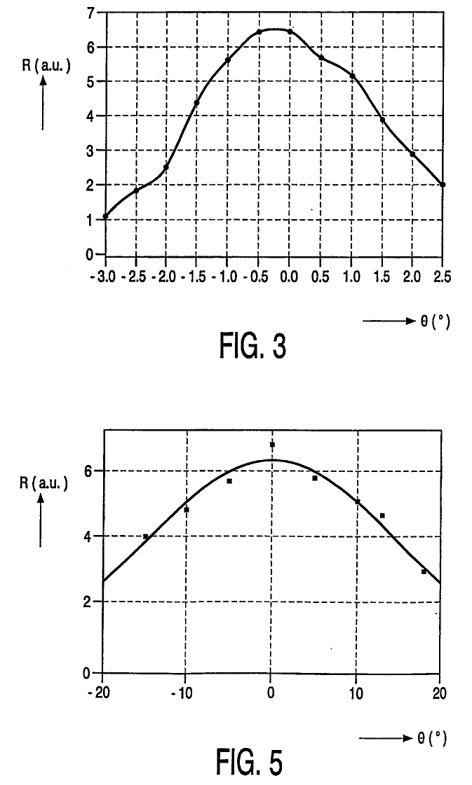

FIG. 3 shows a graph of the reflected intensity R, in arbitrary units, in the direction of incidence as a function of the incident angle θ, in degrees, of white light incident on a combination of a cholesteric layer and an alignment layer not in accordance with the invention,

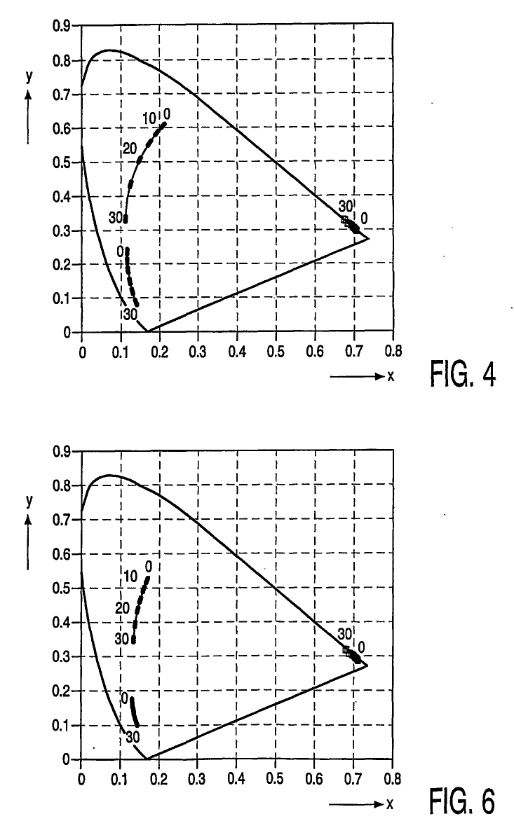

FIG. 4 shows a CIE chromaticity diagram in which calculated CIE color points are plotted as a function of viewing angle (in degrees) of a cholesteric layer ordered in a perfect planar texture and having red green and blue reflection band,

FIG. 5 shows a similar graph as shown in FIG. 3 but relating to a combination of a cholesteric layer and an alignment layer in accordance with the invention, and

FIG. 6 shows a CIE chromaticity diagram in which calculated CIE color points are plotted as a function of viewing angle (in degrees) of a cholesteric layer ordered to have red, green and blue reflection band and a helical axis distribution in accordance with the invention.

Referring to FIG. 1, the reflective display device 1, in the art also referred to as a cholesteric texture liquid crystal (CTLC) device comprises an electro-optical cell 2 comprising cholesteric layer 9 sandwiched two transparent substrates 3 and 5 provided on facing sides with alignment layers 7 and 11 respectively, thus forming a combination 8 of a cholesteric layer 9 and alignment layers 7 and 11. The cell 2 is filled with cholesteric layer 9 which is ordered in a cholesterically ordered wavelength-selectively reflective state, the state being brought about by means of the alignment layers 7 and 11. In accordance with the invention, the alignment layer 7 is a homeotropic alignment layer. The alignment layer 11 is a planar alignment layer. The cell 2 is provided with a light absorbing layer 13 on the side facing away from the viewer 15. The cholesteric layer is switchable between the cholesterically ordered wavelength-selectively reflective state and a transmissive state by means of an electric field. The electric field is conveniently provided by means of electrodes (not shown in FIG. 1) provided on the substrates 3 and 5.

Referring to FIG. 2A, in the on-state, ie with no electric field applied, the cholesteric layer 9 is in the cholesterically ordered wavelength-selectively reflective state, also referred to as the planar texture. An unpolarized light ray 203 having a wavelength within the range of wavelengths which the cholesteric layer 9 is capable of reflecting and which may eg be ambient light or light originating from front light, is split into a reflected light ray 205 and transmitted light ray 207. The reflected light ray 205 and the transmitted light ray 207 are circularly polarized, the polarization state being dependent on the handedness of the cholesterically ordered state. In the figure it is assumed that right-handed circularly polarized light is reflected. The transmitted light ray 207 is absorbed by the light-absorbing layer 13. Unpolarized light ray 209 having a wavelength outside the range of wavelengths which the cholesteric layer 9 is capable of reflecting is substantially transmitted regardless its polarization. Therefore, in the non-adressed state, if white light is incident on the cell 2 appears brightly colored to a viewer 15, the color being determined by the reflection band of the cholesteric layer 9.

Referring to FIG. 2B, in the off-state, ie after having applied an electric field of suitable strength in the direction indicated by arrow 211, the cholesteric layer 9 is brought in a stable state which is not capable of wavelength-selectively reflecting light, eg the fonical conical state, but is transmissive. Consequently, both the light rays 203 and 209 are substantially transmitted and then absorbed by the light-absorbing layer 13. Thus in this state the cell 2 appears dark.

### EXAMPLE 1

### Not in Accordance with the Invention

This example relates to a display device as shown in FIG. 1, with the exception that both alignment layers 7 and 11 are planar alignment layers. Since the device does not comprise a homeotropic alignment layer in direct contact with the cholesteric layer, the combination of alignment layers and cholesteric layer 9 as well as the display device of this example are not in accordance with the invention.

The device of this example 1 is manufactured as follows:

Glass substrates are provided with alignment material AL1051, a polyimide marketed by JSR, Japan, the applied alignment material then being rubbed in a conventional manner to form planar alignment layers 7 and 11. A cell with a well-defined cell gap is formed by gluing the two opposed substrates together along their edges in a conventional manner, the alignment layers 7 and 11 facing each other. A well-defined cell gap is obtained using spacers. The cell is then filled with a cholesteric layer 9 comprising 14.5 wt % nematic liquid crystal material marketed by Merck under the tradename BL087 and 85.5 wt % of a chiral dope marketed by Merck under the tradename BL088.

When brought into a planar texture, this cholesteric layer has a pitch of 400 nm and a reflection band centered at 630 nm. For normally incident white the color of the reflected light is then red. The planar alignment layers serve to bring the cholesteric layer in a cholesterically ordered wavelength-selectively reflective state.

The cell thus obtained is subjected to a beam of white light incident under an angle θ (measured with respect to the normal of the cell surface) and the intensity R of light reflected in that same direction of incidence (by means of a beam splitter the light reflected in the direction of incidence is directed to a detector), integrated over the visual wavelength range (500 to 700 mm), is measured.

FIG. 3 shows a graph of the reflected intensity R, in arbitrary units, in the direction of incidence as a function of the incident angle θ, in degrees, of white light incident on a cell comprising combination of a cholesteric layer and an alignment layer not in accordance with the invention.

In the context of the model in which the cholesteric layer where the perfect or near-perfect planar order is characterized by a helical axis distribution (distributed is the angle helical axes make with the cell surface normal), light reflection in the same direction as the direction of incidence is considered to be substantially result from those helices which have a helical axis which is coincident with the direction of incidence.

Thus as expected, reflection intensity is highest at θ=0° (light incident normal to cell surface) as in the (near-perfect) planar texture most helical axes are aligned along the normal. At small off-axis angles the reflected intensity quickly drops. Light reflection is essentially limited to an angular range of −3.0° to +2.5°. This indicates that the distribution of helical axes is relatively narrow, and accordingly that the reflection is relatively specular as opposed to diffuse. Least-squares-fitting the experimentally determined points shows that the FIG. 3 is approximated well by a Gaussian curve having a 1/e width of about 2°.

Visual inspection of the cell under a variety of viewing angles shows that the reflection is relatively specular and substantial changes in color are observed as a function of viewing angle.

As explained hereinabove and illustrated in FIG. 4, the substantial viewing angle dependency of the color of the light reflected is a result of a narrow helical axis distribution.

FIG. 4 shows a CIE chromaticity diagram in which calculated CIE color points are plotted as a function of viewing angle (in degrees) of a cholesteric layer ordered in a perfect planar texture (no distribution in viewing angle dependency) and having red green and blue reflection band.

Color points are calculated assuming reflection bands having a Gaussian shape with a full 1/e width of 80 nm which are typical for narrow band cholesteric layers. The reflection bands are centered around 700 nm, 520 nm and 480 nm for red, green and blue respectively. The average refractive index is 1.5. White and diffuse ambient lighting conditions. The viewing angle is varied between 0 and 30° which is typical for hand held applications such as mobile phones.

### EXAMPLE 2

### In Accordance with the Invention

Example 1 is repeated with the difference that instead of the planar alignment layer 7 a homeotropic alignment layer is used, resulting in a combination of cholesteric layer and alignment layer and cell comprising such combination in accordance with the invention. In particular, the homeotropic layer is obtained by flex printing a solution of 5.3 wt % alignment material Nissan SE 7511L (marketed by Nissan) in 80%:20% NMP/butylcellosolve solvent mixture.

FIG. 5 shows a similar graph as shown in FIG. 3 but relating to a combination of a cholesteric layer and an alignment layer in accordance with this example 2.

Compared to FIG. 3, and accordingly as a result of the introduction of the homeotropic alignment layer, the angular range in which light is reflected in the direction of incidence has substantially increased.

Within the context of the model in which the cholesteric layer, if ordered in a near-perfect planar texture, may be characterized by a helical axis distribution, the broadened angular range of reflected light indicates that the helical axis distribution has broadened. More particularly, a least-squares fit to a Gaussian (shown as the drawn curve in FIG. 4) yields a 1/e width of 22° which is an order of magnitude larger than the value of FIG. 3.

Comparison of FIG. 5 with FIG. 3 proves that use of a homeotropically alignment layer in combination with a cholesteric layer which is ordered in the cholesterically ordered wavelength-selectively reflective state renders the reflection significantly more diffuse and less specular.

This is confirmed by visual inspection of the cell under a variety of viewing angle and white/diffuse ambient lighting conditions. The visual inspection also indicates that the viewing angle dependence of the color of the light reflected is significantly reduced compared to the cell of example 1. This is further illustrated in FIG. 6. FIG. 6 shows a CIE chromaticity diagram in which calculated CIE color points are plotted as a function of viewing angle (in degrees) of a cholesteric layer ordered to have red, green and blue reflection band and a helical axis distribution in accordance with the invention.

Input parameters for the calculation are identical to those used to calculate the color points shown in FIG. 4, except that the helical axis distribution is assumed to have a full 1/e width of 40°.

1. A combination of a cholesteric layer switchable between a cholesterically ordered wavelength-selectively reflective state and a transmissive state and a homeotropic orientation layer which is in direct contact with the cholesteric layer.

2. A combination as claimed in claim 1 wherein the cholesteric layer is sandwiched between a homeotropic alignment layer and a planar alignment layer.

3. An electro-optical cell, such as a light valve or a display cell, comprising a pair of opposed substrates and a combination as claimed in claim 1 sandwiched between the said pair of substrates.

4. An electro-optical device, such as a display device, comprising a cell as claimed in claim 3.

5. A polymerized cholesteric layer ordered in a cholesterically ordered state capable of wavelength-selectively reflecting polarized light obtainable by polymerizing a polymerizable cholesteric layer in a cholesterically ordered state capable of wavelength-selectively reflecting polarized light, the polymerizable layer being, during polymerization, in direct contact with a homeotropic alignment layer.
